(19) United States
(12) Patent Application Publication
(10) Pub. No.: US 2011/0227913 A1
(43) Pub. Date: Sep. 22, 2011

(54) Method and Apparatus for Controlling a Camera View into a Three Dimensional Computer-Generated Virtual Environment

(76) Inventor: Arn Hyndman, Ottawa (CA)

(21) Appl. No.: 13/117,382

(22) Filed: May 27, 2011

Related U.S. Application Data
(63) Continuation of application No. PCT/CA2009/001715, filed on Nov. 27, 2009.
(60) Provisional application No. 61/118,517, filed on Nov. 28, 2008.

(51) Int. Cl. G06T 15/00

(52) U.S. Cl. 345/419

(57) ABSTRACT

Motion sensors on a portable computing device are used to control a camera view into a three dimensional computer-generated virtual environment. This allows the user to move the portable computing device to see into the virtual environment from different angles. For example, the user may rotate the portable computing device about a vertical axis toward the left to cause the camera angle in the virtual environment to pan to the left. Likewise, rotational motion about a horizontal axis will cause the camera to move up or down to adjust the vertical orientation of the user's view into the virtual environment. By causing the view in the virtual environment that is shown on the display to follow the movement of the portable computing device, the display of the portable computing device appears to provide a window into the virtual environment which provides an intuitive interface to the virtual environment.

### CROSS-REFERENCE TO RELATED APPLICATIONS

This application is a continuation of PCT patent application PCT/CA2009/001715, filed Nov. 27, 2009, which claims priority to U.S. Provisional Patent Application No. 61/118,517, filed Nov. 28, 2008, entitled “Apparatus and Method Suitable for Controlling and Displaying Three-Dimensional Point of View on a Hand Held Device”, the content of each of which is hereby incorporated herein by reference.

### BACKGROUND OF THE INVENTION

1. Field of the Invention

The present invention relates to virtual environments and, more particularly, to a method and apparatus for controlling a camera view into a three dimensional computer-generated virtual environment.

2. Description of the Related Art

Virtual environments simulate actual or fantasy 3-D environments and allow for many participants to interact with each other and with constructs in the environment. One context in which a virtual environment may be used is in connection with gaming, where a user assumes the role of a character and takes control over most of that character's actions in the game. In addition to games, virtual environments are also being used to simulate real life environments to provide an interface for users that will enable on-line education, training, shopping, and other types of interactions between groups of users and between businesses and users.

A virtual environment may be implemented as a stand-alone application, such as a computer aided design package or a computer game. Alternatively, the virtual environment may be implemented on-line so that multiple people may participate in the virtual environment through a computer network such as a local area network or a wide area network such as the Internet. Where the virtual environment is shared, one or more virtual environment servers maintain the virtual environment and generate visual presentations for each user based on the location of the user's Avatar within the virtual environment.

In a virtual environment, an actual or fantasy universe is simulated within a computer processor/memory. Generally, a virtual environment will have its own distinct three dimensional coordinate space. Avatars representing users may move within the three dimensional coordinate space and interact with objects and other Avatars within the three dimensional coordinate space. Movement within a virtual environment or movement of an object through the virtual environment is implemented by rendering the virtual environment in slightly different positions over time. By showing different iterations of the three dimensional virtual environment sufficiently rapidly, such as at 30 or 60 times per second, movement within the virtual environment or movement of an object within the virtual environment may appear to be continuous.

As the Avatar moves within the virtual environment, the view experienced by the user changes according to the user's location in the virtual environment (i.e. where the Avatar is located within the virtual environment) and the direction of view in the virtual environment (i.e. where the Avatar is looking). The three dimensional virtual environment is rendered based on the Avatar's position and view into the virtual environment, and a visual representation of the three dimensional virtual environment is displayed to the user on the user's display. The views are displayed to the participant so that the participant controlling the Avatar may see what the Avatar is seeing. Additionally, many virtual environments enable the participant to toggle to a different point of view, such as from a vantage point outside (i.e. behind) the Avatar, to see where the Avatar is in the virtual environment.

Where the user participating in the virtual environment accesses the virtual environment using a personal computer, the user will typically be able to use common control devices such as a computer keyboard and mouse to control the Avatar's motions within the virtual environment. Commonly, keys on the keyboard are used to control the Avatar's movements and the mouse is used to control the camera angle (where the Avatar is looking) and the direction of motion of the Avatar. One common set of letters that is frequently used to control an Avatar are the letters WASD, although other keys also generally are assigned particular tasks. The user may hold the W key, for example, to cause their Avatar to walk and use the mouse to control the direction in which the Avatar is walking Numerous other specialized input devices have also been developed for use with personal computers or specialized gaming consoles, such as touch sensitive input devices, dedicated game controllers, joy sticks, light pens, keypads, microphones, etc.

As handheld portable computing devices such as personal data assistants, cellular phones, portable gaming devices, and other such devices become more powerful, users of these devices are looking to use these devices to access three dimensional virtual environments. However, at least in part because of the inherent portability of these devices, peripheral controllers commonly available with desktop personal computers and specialized gaming consoles are frequently not available to the users of portable computing devices. For example, a person looking to enter a virtual environment using their cell phone or Personal Data Assistant (PDA) is not likely to carry a mouse and keyboard with them to allow them to interact with the virtual environment.

Accordingly, users of handheld portable computing devices are typically left to the available controls on their handheld portable computing device to control their Avatar within the virtual environment. Generally this has been implemented by using a touch screen on the portable computing device to control the camera angle (point of view) and direction of motion of the Avatar within the virtual environment, and using the portable device's keypad to control other actions of the Avatar such as whether the Avatar is walking, flying, dancing, etc. Unfortunately, these controls can be difficult to master for particular users and do not provide a very natural or intuitive interface to the virtual environment. Accordingly, it would be advantageous to provide a new way of using a handheld portable computing device to interact with a virtual environment.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

Motion sensors on a handheld portable computing device are used to control a camera view into a three dimensional computer-generated virtual environment. This allows the user to move the handheld portable computing device to see into the virtual environment from different angles. For example, the user may rotate the portable computing device about a vertical axis toward the left to cause the camera angle in the virtual environment to pan to the left. Likewise, rotational motion about a horizontal axis will cause the camera to move up or down to adjust the vertical orientation of the user's view into the virtual environment. By causing the view in the virtual environment that is shown on the display to follow the movement of the portable computing device, the display of the handheld portable computing device appears to provide a window into the virtual environment which provides an intuitive interface to the virtual environment.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example system enabling users to have access to three dimensional computer-generated virtual environment according to an embodiment of the invention;

FIG. 2 shows an example of a hand-held portable computing device;

FIG. 3 is a functional block diagram of an example portable computing device for use in the system of FIG. 1 according to an embodiment of the invention;

FIG. 4A shows an example portable computing device oriented in three dimensional space and FIG. 4B shows how movement of the portable computing device within the three dimensional space affects orientation of the camera angle via point of view control software;

FIG. 5 shows an example virtual environment;

FIG. 6 shows an iteration of the virtual environment of FIG. 5 on a portable computing device;

FIG. 7 shows an example movement of the portable computing device and the effect of the movement on the camera view angle into the virtual environment according to an embodiment of the invention; and

FIG. 8 shows another example movement of the portable computing device and the effect of the movement on the camera view angle into the virtual environment according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

FIG. 1 shows a portion of an example system 10 that may be used to provide access to a network-based virtual environment 12. The virtual environment 12 is implemented by one or more virtual environment servers 14. The virtual environment servers maintain the virtual environment and enable users of the virtual environment to interact with the virtual environment and with each other. Users may access the virtual environment over a communication network 16. Communication sessions such as audio calls between the users may be implemented by one or more communication servers 18 so that users can talk with each other and hear additional audio input while engaged in the virtual environment. Although FIG. 1 shows a network-based virtual environment, other virtual environments may be implemented as stand-alone applications, and the invention is not limited to interaction with a network-based environment.

In a network-based virtual environment, a user may access the network-based virtual environment 12 using a computer with sufficient hardware processing capability and required software to render a full motion 3D virtual environment. Alternatively, the user may desire to access the network-based virtual environment using a device that does not have sufficient processing power to render full motion 3D virtual environment, or which does not have the correct software to render full motion 3D virtual environment. Where the device being used to access the virtual environment does not have sufficient processing capability to render the virtual environment, or does not have the correct software instantiated, a rendering server 20 may be used to render the 3D virtual environment for the user. A view of the rendered 3D virtual environment is then encoded into streaming video which is streamed to the user over the communication network and played on the device. One way to create streaming video of a virtual environment is disclosed in a PCT Patent Application filed in the Canadian Receiving Office on Nov. 27, 2009 (Attorney Docket No. 18938ROWO02W) entitled “Method And Apparatus For Providing A Video Representation Of A Three Dimensional Computer-Generated Virtual Environment” the content of which is hereby incorporated herein by reference.

One way to access the three dimensional virtual environment is through the use of a portable computing device 22. Example portable computing devices that are commercially available include smart phones, personal data assistants, handheld gaming devices, and other types of devices. The term “portable computing device” will be used herein to refer to a device that includes an integrated display that the user can view when looking at the device or otherwise interacting with the device.

Portable computing devices may be capable of rendering full motion 3D virtual environments or may require the assistance of the rendering server to view full motion 3D virtual environments. Regardless of whether the virtual environment is being rendered on the device or rendered by a server on behalf of the device, the user will interact with the available controls on the portable computing device to control their Avatar within the virtual environment and to control other aspects of the virtual environment. Since the portable computing device includes an integrated display, the user will be able to see the virtual environment on the portable computing device while looking at the display on the portable computing device.

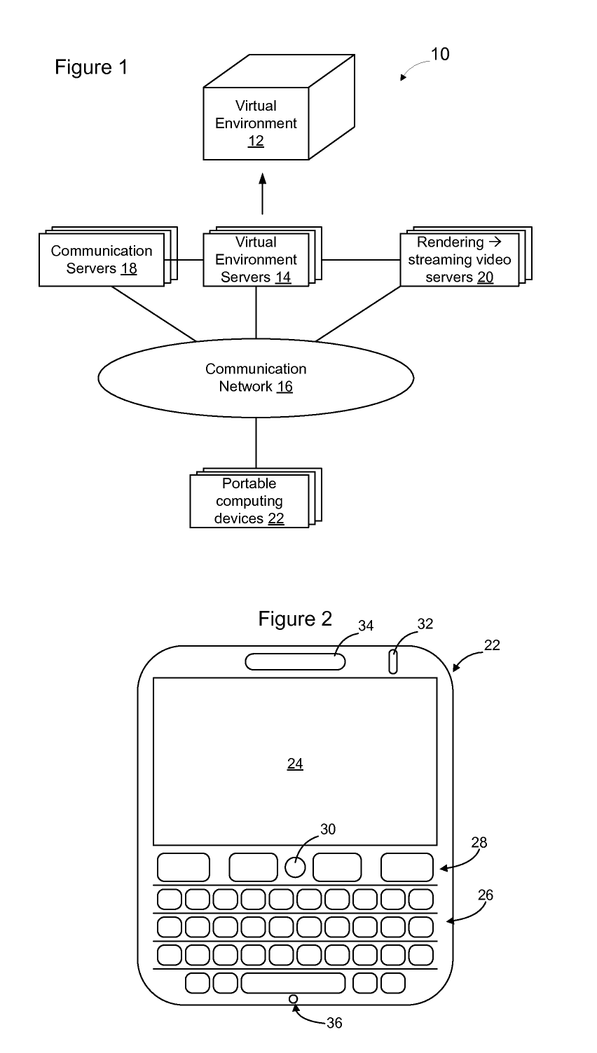

FIG. 2 shows one example of a portable computing device 22. In the example shown in FIG. 2, the portable computing device includes integrated display 24, keypad/keyboard 26, special function buttons 28, trackball 30, camera 32, speaker 34, and microphone 36. The integrated display may be a color LCD or other type of display, which optionally may include a touch sensitive layer to enable the user to provide input to the portable computing device by touching the display. Where the portable computing device includes a touch sensitive display, the touch sensitive display may replace the physical buttons on the portable computing device, such as the keypad/keyboard 26, special function buttons 28, trackball, etc. In this instance, the functions normally accessed via the physical controls would be accessed by touching a portion of the touch sensitive display.

As shown in FIG. 2, the portable computing device may have limited controls, which may limit the type of input a user can provide to a user interface to control actions of their Avatar within the virtual environment and to control other aspects of the virtual environment. Accordingly, the user interface may be adapted to enable different controls on different devices to be used to control the same functions within the virtual environment. As described in greater detail herein, motion sensors on the portable computing device may be used to control the camera angle into the virtual environment to enable the user to move the portable computing device to see into the virtual environment from different angles. This allows the user, for example, to rotate the portable computing device to the left to cause the camera angle in the virtual environment to pan to the left. Since the portable computing device has a built-in display, this will cause the virtual environment shown on the display to follow the movement of the portable computing device so that it appears that the display is showing a window into the virtual environment. Additional details about how this may be implemented are provided in greater detail below.

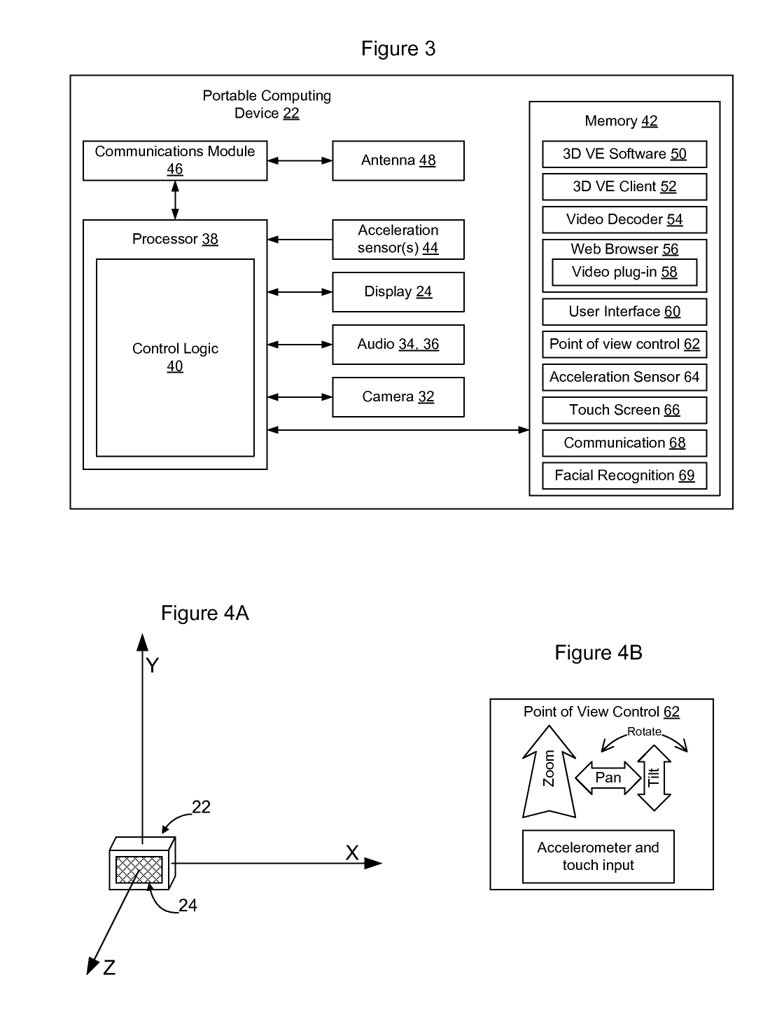

FIG. 3 shows a functional block diagram of an example portable computing device 22 that may be used to implement an embodiment of the invention. In the embodiment shown in FIG. 3, the portable computing device 22 includes a processor 38 containing control logic 40 which, when loaded with software from memory 42, causes the portable computing device to use motion sensed by motion sensors 44 to control a camera angle into a virtual environment 12 being shown on display 24. Where the portable computing device is capable of communicating on a communication network, such as a cellular communication network or wireless data network (e.g. Bluetooth, 802.11, or 802.16 network) the portable computing device will also include a communications module 46 and antenna 48. The communications module 46 provides baseband and radio functionality to enable the portable computing device to receive and transmit data on the communication network 16.

The memory 42 includes one or more software programs to enable a virtual environment to be viewed by the user on display 24. The particular selection of programs installed in memory 42 will depend on the manner in which the portable computing device is interacting with the virtual environment. For example, if the portable computing device is operating to create its own virtual environment, the portable computing device may run a three dimensional virtual environment software package 50. This type of 3D VE software enables the portable computing device to generate and maintain a virtual environment on its own, so that the portable computing device is not required to interact with a virtual environment server over the communication network. Computer games are one common example of stand-alone 3D VE software that may be instantiated and run on a portable computing device.

If the portable computing device is to be used to access a network-based virtual environment, and the portable computing device has sufficient processing power in processor 38 (and optionally via additional hardware acceleration circuitry), a three dimensional virtual environment client 52 may be loaded into memory 42. The 3D VE client allows the 3D virtual environment to be rendered on the portable computing device to be displayed on display 24.

Where the portable computing device is to be used to access a network-based virtual environment, and the portable computing device does not have sufficient processing power to render the 3D virtual environment, then the portable computing device may receive a streaming video representation of the virtual environment from the rendering server 20. The streaming video representation of the virtual environment will be decoded by a video decoder 54 for presentation to the user via display 24. Optionally, rather than utilizing a virtual environment specific video decoder, the portable computing device may utilize a web browser 56 with video plug-in 58 to receive a streaming video representation of the virtual environment.

As described in the preceding several paragraphs, the particular selection of software that is implemented on the portable computing device will depend on the particular capabilities of the device and how it is being used. Accordingly, although FIG. 3 shows the memory as having 3D virtual environment software 50, 3D virtual environment client 52, video decoder 54, and web browser/plugin 56/58, it should be understood that only one or possibly a subset of these components would be needed in any particular instance.

As shown in FIG. 3, the memory 42 of portable computing device 22 also contains several other software components to enable the user to interact with the virtual environment. The user interface collets user input from the motion sensors 44, display 24, and other controls such as the keypad, etc., and provides the user input to the component responsible for rendering the virtual environment. Thus, the user interface 60 enables input from the user to control aspects of the virtual environment. For example, the user interface may provide a dashboard of controls that the user may use to control his Avatar in the virtual environment and to control other aspects of the virtual environment. The user interface 60 may be part of the virtual environment software 50, virtual environment client 52, plug-in 58, or implemented as a separate process.

A point of view control software package 62 may be instantiated in memory 42 to control the point of view into the virtual environment that is presented to the user via display 24. The point of view control 62 may be a separate process, as illustrated, or may be integrated with user interface 60 or one of the other software components. According to an embodiment of the invention, the point of view software works in connection with a motion sensor module 64 designed to obtain movement information from the motion sensors 44 to control the camera angle into the virtual environment.

The memory also includes other software components to enable the portable computing device to function. For example, where the portable computing device is equipped with a touch-sensitive display, the memory 42 may contain a touch screen application 66 to control the touch sensitive display. Touch screen application 66 facilitates processing of touch input on touch sensitive display using a touch input algorithm, such as known multi-touch technology which can detect multiple touches for zooming in and out and/or rotation input, as well as more traditional single touch input on virtual keys, buttons, and keyboards.

Other programs may be loaded in the portable computing device as well and the example list of applications stored in memory 42 is merely intended to illustrate an example selection of programs intended to enable the motion sensors 44 on the portable computing device to be used to control the camera angle into the virtual environment that will be shown on the display 24.

Input from the motion sensors 44 will be interpreted using point of view control software 62 and conveyed, via the user interface 60, to the software component that is responsible for rendering the 3D virtual environment. The term “user input” will be used herein to refer to input from the user that is received by the portable computing device, and includes the input sensed by the motion sensors on the portable computing device. The user input may be used natively on the portable computing device to control the virtual environment or may be forwarded to whatever device is rendering the virtual environment to control the virtual environment that is being displayed on the portable computing device.

Where the software rendering the 3D virtual environment is instantiated on the portable computing device (e.g. 3D VE software 50, or 3D VE client 52), the user input, including the user input from the motion sensors 44, will be provided to those processes. Where the 3D virtual environment is being rendered on behalf of the portable device, e.g. by being rendered by rendering server 20, then the user input, including the user input from the motion sensors 44 and any other input from the user (e.g. via touch sensitive display 24, key pad 26, track ball 30, etc.), will be sent via a communication program 68 to the rendering server 20. The communication program may be specific to the virtual environment or may be a more generic process designed to communicate the user input to the rendering server to allow the user to control the virtual environment even though it is not being rendered locally.

Motion sensors 44 may be implemented using accelerometers or, alternatively, using one or more microelectromechanical system (MEMS) gyroscopes. Accelerometers typically are used to determine motion relative to the direction of gravity. MEMs gyroscopes typically sense motion along a single axis or rotation about a single axis. Thus, several motion sensors may be used to sense overall motion of the portable computing device about multiple axes, or a more expensive multi-axis sensor may be used to compute the total device motion. Motion sensors 44 may be implemented using any type of sensor capable of detecting movement and, accordingly, the invention is not limited to an embodiment that utilizes input from only one or another particular type of sensor.

As explained in connection with FIG. 3, the portable computing device includes one or more motion sensors, which allow motion of the portable computing device to be sensed by the portable computing device. FIGS. 4A and 4B the portable computing device in three dimensional coordinate space and show an example point of view control program 62 that can use input from the motion sensors of the portable computing device to control the camera angle in the virtual environment to provide a more natural way for a person to use a portable computing device to interact with the virtual environment.

As shown in FIGS. 4A-4B, the motion sensors can sense many types of movement of the portable computing device. These movements can cause the camera view angle in the virtual environment to pan left/right, tilt up/down, to switch viewpoints such as between first and third person point of view, or to zoom in to focus on particular parts of the virtual environment. Likewise, rotational movement of the portable computing device may cause the view to rotate within the 3D virtual environment.

In addition to using motion sensors, the portable computing device may also be equipped with a camera and use head tracking to determine the location of the user's head relative to the portable computing device. Where the portable computing device has a front mounted camera 32 (camera facing the user when the user is looking at the screen), the portable computing device will be able to have a view of the user as the user interacts with the 3D virtual environment. Using facial recognition software 69, the location of the user's head (i.e. distance from the screen and angle relative to the screen) can be used to adjust the point of view into the virtual environment. For example, the relative size of the user's head in the camera frame may be used to estimate the distance of the user's head from the screen. This information can be used to roughly position the user in 3D space relative to the screen, which can be used to adjust the point of view, field of view, and view plane of the 3D rendering that is displayed on the screen.

For example, as the user moves the portable computing device, the direction in which the portable computing device is pointed will control the camera angle into the virtual environment. The screen will provide a window to the user at that camera angle and the user's head relative to the screen will be used to adjust the user's point of view at the camera location and orientation. Thus, if the user holds the portable device straight in front of them and rotates in a circle, the camera within the virtual environment would move in a circle centered at the user's current location with a radius defined by the length of the user's arm. While keeping the portable computing device still, the user can then move their head to get different points of view at that camera location and direction. Thus, in this embodiment the position of the user's head relative to the screen adjusts the point of view at a particular camera angle, and the camera angle is adjusted by moving the portable computing device.

Additionally, the distance of the user's head relative to the screen may be used to adjust the width of the field of view. Thus, as the user moves their face toward the screen the user will be provided with a wider field of view into the virtual environment just like if the user were to approach a real window in the real world. In the real world, if a person stands close to a window the user can see more of the outdoors than if the person steps back a few paces. This is because the field of view (the amount of lateral view afforded through the window) decreases as a person gets farther away from the window. By tracking the distance of the user's head relative to the screen, this same effect may be provided to the user so that the user may bring the screen closer to obtain a wider field of view into the virtual environment. The location of the screen of the portable handheld device is then used by the rendering process to set the view plane. The combination of using motion sensors to adjust the camera angle and head tracking to adjust the point of view enables the screen on the handheld portable computing device to simulate a window into the virtual environment. This provides an increased sensation of being immersed in the virtual environment to help engage the user and provide an intuitive interface to the virtual environment where the user is accessing the virtual environment via a handheld portable computing device.

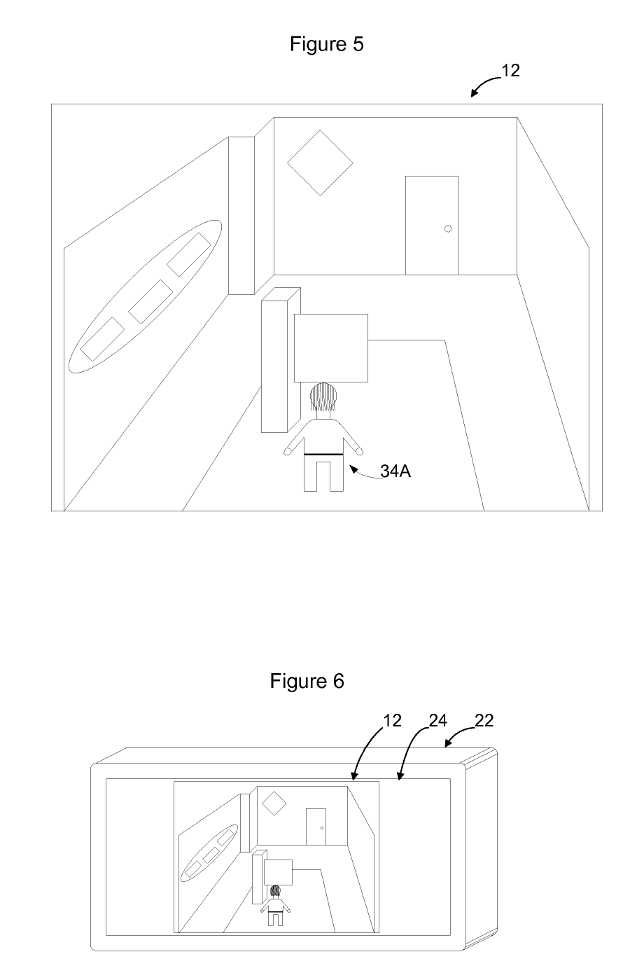

For example, FIG. 4A shows the portable computing device 22 with integrated display 24 oriented in three dimensional (X, Y, Z coordinate) space. A view of the virtual environment, such as the virtual environment shown in FIG. 5, is shown on the display 24. FIG. 6 shows how the virtual environment 12 may appear when shown on display 24 of portable computing device 22.

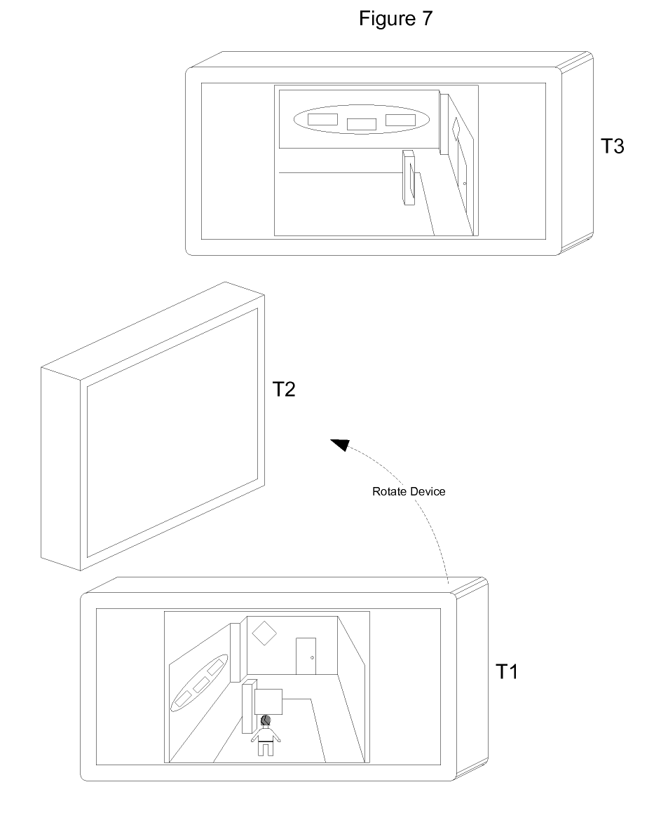

If the user would like their view into the virtual environment to pan toward the left, the user may rotate the portable computing device about the Y axis. An example of how this may occur is shown in FIG. 7. Specifically, in FIG. 7, at time T1 the user initially has a view into the virtual environment as shown in FIG. 6. Then, at time T2 the user rotates their portable computing device about the Y axis. This motion is sensed by the motion sensors 44 and provided to the point of view control 62. The point of view control interprets this as an instruction from the user to pan the camera angle toward the left within the virtual environment. Accordingly the point of view control will instruct the 3D VE software 50, client 52, or rendering server 24 (via communication client 68) to change the point of view by causing the camera to pan toward the left. Thus, as shown at time T3 the view into the virtual environment will have changed as instructed by the user by changing the orientation of the portable computing device.

The user may use a similar motion to cause the camera angle to tilt up/down by causing the portable computing device to be rotated about the X-axis. Specifically, when the user rotates the portable computing device about the X-axis, the display 24 on the portable computing device will be angled more toward the ceiling or angled more toward the floor. This motion is translated into movement of the camera angle so that the same motion is experienced in the virtual environment.

The user may also rotate the portable computing device about the Z axis to cause the point of view camera to rotate e.g. spin. This may be useful, for example, in a virtual environment where the user is controlling an airplane or other object that may require the view to spin. Optionally, where rotation of the camera is not a normal or useful type of motion to control, the rotational motion of the portable computing device about the Z axis may be used to control other aspects of the camera angle, such as whether the camera is in first person or third person.

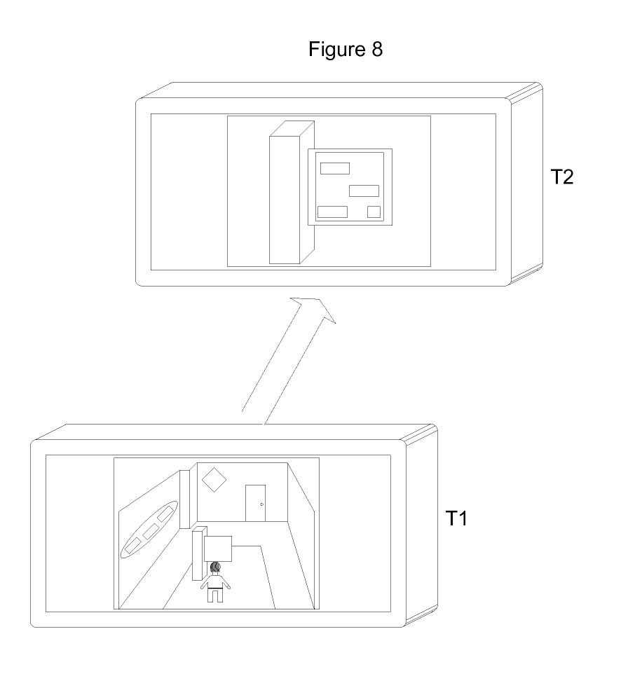

The motion sensors of the portable computing device may also sense linear movement as well, depending on the particular implementation. For example, as shown in FIG. 8, if the view into the virtual environment is initially in third person point of view (at time T1), a sharp movement of the computing device along the Z axis may cause the point of view to toggle from third person to first person point of view (time T2). If the viewpoint is already in first person point of view, movement of the portable computing device along the Z axis may cause the camera to zoom in, e.g. to show an aspect of the virtual environment in greater detail, or more likely, cause the camera and hence the Avatar to move forward in the virtual environment. Likewise, movement of the portable computer device in the vertical direction may be used to cause the camera to move up, etc.

Since the portable computing device may be used in environments where the user is mobile, i.e. a person may be using the portable computing device while riding as a passenger in a car, on a train, airplane, etc., in some embodiments longitudinal movement may be ignored in particular situations to avoid having ambient motion of the portable computing device from being translated into movement of the camera unintentionally. In the previous description, the use of motion sensors to control the camera angle was described. It is common in many virtual environments for the camera angle to correspond with the orientation of the user's Avatar within the virtual environment. Hence, where the Avatar is walking or otherwise moving within the virtual environment, controlling the camera angle also controls the direction of movement of the Avatar. Depending on the particular embodiment, the motion sensors may be used to control only the camera view angle into the virtual environment or may also be used to control the direction of motion of the Avatar within the virtual environment.

Using the motion sensors to control the camera angle provides an intuitive interface into the virtual environment. Specifically, since the view into the virtual environment mirrors the angular orientation of the portable computing device, and since the view into the virtual environment is also shown directly on the portable computing device (on the integrated display on the portable computing device), the combination makes it seem as if the portable computing device is providing a window into the virtual environment. If a user wants to peer around a corner in the virtual environment, the user can simply move the portable computing device to point the direction in which the user would like to look. The virtual environment camera angle changes as the portable computing device is moved to show a vantage into the virtual environment in that direction. Likewise, if the user would like to look down, the user can angle the portable computing device to point down, and the view shown to the user of the virtual environment corresponds to the user's movements.

New users to virtual environments sometimes have difficulty learning how to control their Avatar within the virtual environment. By using the motion sensors to control the camera angle in the virtual environment, the user can simply aim their portable computing device toward where they would like to look in the virtual environment and the view shown to the user on their portable computing device will adjust accordingly. Thus, controlling the camera angle via the motion sensors provides a natural and intuitive interface to the virtual environment.

Optionally, the point of view control 62 may be a user-selectable tool for use in connection with interacting with the virtual environment. In this embodiment the point of view control may be displayed and accessible to the user of the virtual environment at all times. In other embodiments the point of view control may be toggled on/off by the user so that the user can select when motion of the portable computing device should be interpreted to control an aspect of the virtual environment. In one embodiment, to avoid having the control unintentionally toggled on/off, the user may activate the tool by touching and holding an area of the touch sensitive screen (e.g. a particular area of a navigation tool on the edge of the screen) for a predetermined time period, for example, one to two seconds. An activated tool is preferably transparent to avoid hindering the display of content information in the viewing area. Alternatively, the tool may change colors or other features of its appearance to indicate its active status. A solid line image, for example, may be used in grayscale displays that do not support transparency. The region for activation of the tool is preferably on an edge of the screen so that the user's hand does not obscure the view into the virtual environment while activating or deactivating the point of view control.

The point of view control 62 may work with the touch screen application 66 in other ways as well to enable the combination of the input from the touch screen and from the motion sensors to be used to control particular actions in the virtual environment.

The user may move the portable computing device while standing by rotating around in a circle, while sitting by moving the portable computing device in their hands, or in other ways. Likewise, the point of view control 62 may be configured to interpret gestures as well as motion. For example, if the user quickly rotates the device about the Y axis the view may pan quickly to the left. However, if the user then slowly rotates the device back to where it was, the slow rotation in the opposite direction may not affect the point of view into the 3D virtual environment so that the user can hold the personal computing device directly in front of them again. Other gestures such as shaking motions, arched motions, quick jabbing motions, and other types of gestures may be used to control other aspects of the camera into the virtual environment as well.

Gestures may also be combined with other input such as button presses or touching the screen in particular locations to further refine control over the camera angle in the virtual environment. For example, the user may want to rotate the camera angle in 360 degrees. By pressing a button or touching the screen in a particular area, and then turning the device toward the direction in which the camera is to pan, the camera may be caused to pan in a complete circle. As another example, a user may want to look in one direction more than the amount which is visible by simply aiming the portable computing device in that direction, i.e. the user may want to look 90 degrees to the left. Aiming the portable computing device in that direction may cause the camera angle to be moved to show a view into the virtual environment 90 degrees to the left, but he user may not be able to see the screen anymore. A button on the device or a touch area on the screen may be used to temporarily disable point of view control so that the user can rotate the camera angle part way, touch the disable area while returning the portable computing device back to parallel with the user, and then reactivate point of view control to continue panning the camera to the left. This ability to temporarily suspend point of view control may thus allow the user to reset its default (straight ahead) view into the virtual environment.

In the previous discussion, it was assumed that angular movement of the portable computing device would have a one-to-one correspondence with angular movement of the camera angle in the virtual environment. In other embodiments, a multiplication factor may be implemented (optionally user selectable via a button or touch area on the screen) such that movement of the portable computer device is translated into a greater amount (or lesser amount) of angular camera movement within the virtual environment. For example, movement of the portable computing device 30 degrees may cause a 60 degree movement of the camera angle in the virtual environment. Similarly, a 30 degree movement of the portable computing device may be translated into a lesser amount, say 15 degree, movement of the camera angle in the virtual environment. The magnitude of the multiplication factor that translates movement of the portable computing device into movement in the virtual environment may be user selectable.

When a three dimensional virtual environment is to be rendered for display, the 3D rendering process will create an initial model of the virtual environment, and in subsequent iterations traverse the scene/geometry data to look for movement of objects and other changes that may have been made to the three dimensional model. The 3D rendering process will also look at the aiming and movement of the view camera to determine a point of view within the three dimensional model. Knowing the location and orientation of the camera allows the 3D rendering process to perform an object visibility check to determine which objects are occluded by other features of the three dimensional model. According to an embodiment of the invention, the camera movement or location and aiming direction are based on input from the motion sensors. All other rendering and encoding process steps are implemented as normal and, accordingly, a detailed explanation of the 3D rendering process has been omitted. Likewise, where the rendering is implemented by a rendering server, the steps associated with encoding the rendered 3D virtual environment to streaming video will be performed as normal. Accordingly, a detailed description of the optional video encoding process has been omitted. Details about a possible 3D rendering process and an associated video encoding process are contained in PCT Patent Application filed in the Canadian Receiving Office on Nov. 27, 2009 (Attorney Docket No. 18938ROWO02W) entitled “Method And Apparatus For Providing A Video Representation Of A Three Dimensional Computer-Generated Virtual Environment” the content of which is hereby incorporated herein by reference.

The functions described above may be implemented as one or more sets of program instructions that are stored in a computer readable memory within the network element(s) and executed on one or more processors within the network element(s). However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of controlling a camera view into a three dimensional computer-generated virtual environment, the method comprising the steps of:
obtaining user input from one or more motion sensors incorporated into a hand-held portable computing device, the portable computing device including an integrated display;
conveying the user input to a rendering process, the rendering process being responsible for rendering the three dimensional computer-generated virtual environment; and
displaying a view into the three dimensional computer-generated virtual environment on the integrated display of the portable computing device;
wherein the user input from the one or more motion sensors is used by the rendering process to adjust a camera location and orientation used to create the view into the virtual environment that is displayed on the integrated display of the portable computing device.

2. The method of claim 1, wherein the one or more motion sensors are acceleration sensors.

3. The method of claim 1, wherein the one or more motion sensors are MEMS gyroscopes.

4. The method of claim 1, wherein the user input is movement, by the user, of the hand-held portable computing device.

5. The method of claim 4, wherein movement of the hand-held portable computing device causes the display on the hand-held portable computing device to be angled relative to a viewing position of the user, and wherein the camera location and orientation of the view into the virtual environment angularly changes a corresponding amount.

6. The method of claim 5, further comprising implementing a multiplication factor such that movement of the hand-held portable computing device to cause the display on the hand-held portable computing device to be angled at a first angle relative to a viewing position of the user will cause an angle of the camera orientation within the virtual environment to be angled a proportionate amount, the proportionate amount being determined by multiplying the multiplication factor times the first angle.

7. The method of claim 6, wherein the user may depress a button or touch an area of the display to adjust the multiplication factor.

8. The method of claim 1, further comprising enabling the user to set a default angle of view into the virtual environment.

9. The method of claim 8, wherein the user may depress a button or touch an area of the display to temporarily disable point of view control such that movement of the handheld portable computing device will not affect the camera angle into the virtual environment.

10. The method of claim 1, wherein the user may depress a button or touch an area of the display to toggle on/off whether movement of the handheld portable computing device will affect the camera orientation and location within the virtual environment.

11. The method of claim 1, wherein rotation of the portable computing device about a vertical axis will cause the camera orientation in the virtual environment to pan to the left or to the right.

12. The method of claim 1, wherein rotation of the portable computing device about a horizontal axis will cause the camera orientation in the virtual environment to tilt up or tilt down.

13. The method of claim 1, wherein longitudinal motion of the portable computing device toward or away from the user is further translated into a camera zoom action in the virtual environment.

14. The method of claim 1, wherein movement gestures of the handheld portable computing device are interpreted to control the camera within the virtual environment.

15. The method of claim 14, wherein the gestures include differences between quick movements and slow movements.

16. The method of claim 14, wherein gestures are only interpreted by the handheld portable computing device in connection with associated button pushes or screen touches.

17. The method of claim 1, wherein the step of displaying a view into the three dimensional computer-generated virtual environment on the integrated display of the portable computing device causes the view in the virtual environment that is shown on the display to follow the movement of the portable computing device such that the display of the handheld portable computing device appears to provide a window into the virtual environment.

18. The method of claim 1, further comprising the step of detecting a location of the user's head relative to the display, and using the location of the user's head to determine a point of view, field of view, and view plane used for rendering the virtual environment shown to the user on the display.

19. The method of claim 18, wherein the portable computing device includes a camera facing the direction of the display, and wherein the location of the user's head is determined by the camera.
